(19) United States
(12) Patent Application Publication
(10) Pub. No.: US 2009/0027356 A1
(43) Pub. Date: Jan. 29, 2009

(54) Capacitive Touch Switch

(75) Inventors: Uwe Heimann, Wangen (DE); Michael Prinz, Leutkirch (DE)

Correspondence Address: LERNER GREENBERG STEMER LLP, P O BOX 2480, HOLLYWOOD, FL, 33022-2480, US

(73) Assignee: DIEHL AKO STIFTUNG & CO. KG, Wangen (DE)

(21) Appl. No.: 12/168,582

(22) Filed: Jul. 7, 2008

(30) Foreign Application Priority Data
Jul. 26, 2007 (DE) 102007035455.1

(51) Int. Cl. G06F 3/045

(52) U.S. Cl. 345/174

(57) ABSTRACT

A capacitive touch switch has a touch panel with a top side and an underside. A circuit board is arranged at a spacing under the underside of the touch panel. A capacitive sensor element which is arranged at the underside of the touch panel and which is in electrically conductive contact with the circuit board is disposed or formed on a circuit carrier that is flexible and three-dimensionally deformable for adaptation to the freely shaped underside of the touch panel.

### CROSS-REFERENCE TO RELATED APPLICATION

This application claims the priority, under 35 U.S.C. §119, of German patent application DE 10 2007 035 455.1, filed Jul. 26, 2007; the prior application is herewith incorporated by reference in its entirety.

### BACKGROUND OF THE INVENTION

### Field of the Invention

The invention pertains to a capacitive touch switch having a touch panel with a top side and an underside. A circuit board is arranged at a spacing distance below the underside of the touch panel. A capacitive sensor element is disposed at the underside of the touch panel and is electrically connected with the circuit board.

Our commonly assigned published patent application US 2007/0103451 A1 and its German counterpart DE 10 2005 053 792 A1 disclose a capacitive touch switch of the general kind. There, the sensor elements are formed by springs disposed between a circuit board and the underside of the touch panel. A disadvantage with that arrangement however is that the spacing to be bridged over by the springs must be substantially approximately equal for all sensor elements in order to permit uniform evaluation of the capacitive signal. A further disadvantage is that the underside of the touch panel must be a flat surface and it is thus not possible for a freely shaped touch panel to be equipped with capacitive touch switches.

### SUMMARY OF THE INVENTION

It is accordingly an object of the invention to provide a capacitive touch switch, which overcomes the above-mentioned disadvantages of the heretofore-known devices and methods of this general type and which provides for a capacitive touch switch that can be used on freely shaped surfaces.

With the foregoing and other objects in view there is provided, in accordance with the invention, a capacitive touch switch, comprising:

a touch panel having a top side and an underside;

a circuit board disposed at a spacing distance below the underside of the touch panel;

a flexible and three-dimensionally deformable circuit carrier configured for adaptation to a freely shaped surface of the underside of the touch panel; and

a capacitive sensor element disposed on the circuit carrier and at the underside of the touch panel and in electrically conductive contact with the circuit board.

In other words, according to the invention the above and other objects are attained by a capacitive touch switch having a touch panel with a top side and an underside; a circuit board arranged at a spacing under the underside of the touch panel; and a capacitive sensor element which is arranged at the underside of the touch panel and which is electrically conductingly in contact with the circuit board, wherein the capacitive sensor element is arranged on a circuit carrier which is flexible and three-dimensionally deformable for adaptation to the freely shaped underside of the touch panel.

There is provided a capacitive touch switch having a touch panel with a top side and an underside, with a circuit board arranged at a spacing therefrom, wherein the circuit board is electrically conductingly connected to a capacitive sensor element arranged at the underside of the touch panel. It is particularly advantageous for a capacitive sensor element to be arranged on a flexible and three-dimensionally deformable circuit carrier which, by virtue of its flexibility and deformability, can be adapted to the freely shaped underside of the touch panel and thereby ensures a uniform spacing between the sensor element and the top side of the touch panel. That uniform spacing permits particularly simple evaluation of the capacitive signal.

In order to more clearly emphasize the position of a capacitive touch switch on the touch panel the location of the touch panel at which the switch is disposed could be identified for example by a rising, rounded-off raised portion. The raised portion is not filled with material at the underside of the touch panel but adapted while maintaining the thickness of the material of the touch panel at the raised portion. It is advantageous for a circuit carrier with a capacitive sensor element to be arranged in the hollow space of the dome, that is to say at the freely shaped underside of the touch panel, wherein the circuit carrier at the underside of the touch panel fits into the dome-shaped hollow space.

With the above and other objects in view there is also provided, in accordance with the invention, a capacitive touch switch having a touch panel with a top side and an underside; a circuit board arranged at a spacing under the underside of the touch panel; and a capacitive sensor element which is electrically conductingly in contact with the circuit board, wherein the capacitive sensor element is arranged on a circuit carrier which is flexible and three-dimensionally deformable for adaptation to the freely shaped underside of the touch panel, wherein the circuit carrier is at least partially integrated into the touch panel.

In a capacitive touch switch of that kind the flexible and three-dimensionally deformable circuit carrier on which the capacitive sensor element is arranged is at least partially integrated into a freely shapeable touch panel, for example by injection molding therearound. It is possible for example for raised portions of the touch panel to be implemented in that way and that ensures a uniform spacing between the circuit carrier and the touch panel surface by virtue of the deformability of the circuit carrier, whereby uniform switchability of the sensor elements is achieved.

In an advantageous development the capacitive sensor element is integrated into the circuit carrier. That achieves a protection function for the sensor element and reduces the susceptibility to trouble of the touch switch.

In a preferred alternative the capacitive sensor element is arranged on the front side and/or the rear side of the circuit carrier. That provides an advantageous solution with which optimum account can be taken of the adaptation requirements depending on the respectively available space in the touch switch.

In a further embodiment the circuit carrier has interference suppression and/or shielding and/or protection elements. Those means ensure that the sensor elements are shielded from such electronic components which are to be found in the surrounding area, in respect of adverse and unwanted interactions.

Advantageously the circuit carrier is strip-shaped, round or oval. In that way the circuit carrier can be particularly well adapted to the available space and in addition implement wishes in terms of altering the layout of the touch switch.

In accordance with a desirable embodiment of the invention, the circuit carrier has incisions and/or cut-outs to improve adaptability. The adaptability of the circuit carrier can be further improved by such openings.

In a further configuration the capacitive sensor element is of a rectangular, square, round, oval or segment-shaped configuration. That makes it possible to emulate various button shapes with at the same time a high level of sensor efficiency.

In a further configuration the circuit carrier adapted to the freely shaped underside of the touch panel is permanently connected to the underside of the touch panel, in particular by adhesive or riveting. That measure provides that the capacitive touch switch operates in trouble-free manner as the circuit carrier and the sensor are not releasably connected to the touch panel.

Advantageously the circuit carrier adapted to the freely shaped underside of the touch panel is releasably connected to the underside of the touch panel, in particular by peening, screwing, compression springs, clamps or bonding hooks. That makes it possible for circuit carriers to be replaceable in a fault situation.

In a particularly advantageous development the feed lines to the capacitive sensor element pass by way of a cable tail of the circuit carrier. The term cable tail is used to denote the sensor-free region of the flexible circuit carrier, by way of which region feed lines pass. The cable tail can be narrower than the circuit carrier and can be provided at its end with a commercially available plug for contacting the circuit carrier with the circuit board. Feed lines of that kind are particularly inexpensive as they can already be applied to the circuit carrier upon manufacture thereof and no additional cabling is required.

In an advantageous development the circuit carrier is arranged directly at the underside of the touch panel. As no further components are required this is a particularly inexpensive design configuration.

In a preferred alternative the circuit carrier is at least partially encapsulated, wherein the encapsulation of the circuit carrier is adapted to the freely shaped underside of the touch panel and is arranged at the underside of the touch panel. The circuit carrier is therefore at least partially encapsulated for example by injection molding therearound and in that respect the encapsulation is such that the surface of the encapsulation of the circuit carrier is adapted to the freely shaped underside of the touch panel. In that way the circuit carrier is provided in a particularly assembly-friendly fashion and the encapsulation is finally arranged at the underside of the touch panel.

In a further embodiment a plurality of capacitive sensor elements are arranged on a circuit carrier. In that respect it is particularly advantageous if the plurality of capacitive sensor elements are electrically insulated from each other. It is possible in that way to produce capacitive touch switches having a plurality of switching locations.

Other features which are considered as characteristic for the invention are set forth in the appended claims.

Although the invention is illustrated and described herein as embodied in capacitive touch switch, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 is a perspective and diagrammatic illustration of a capacitive touch switch in the disassembled state;

FIGS. 2A and 2B are plan views of circuit carriers of a round configuration with sensor elements of different shapes;

FIGS. 3A and 3B are plan views of circuit carriers in a strip form with sensor elements of different shapes; and

FIG. 4 is a plan view of a circuit carrier of an annular configuration.

### DETAILED DESCRIPTION OF THE INVENTION

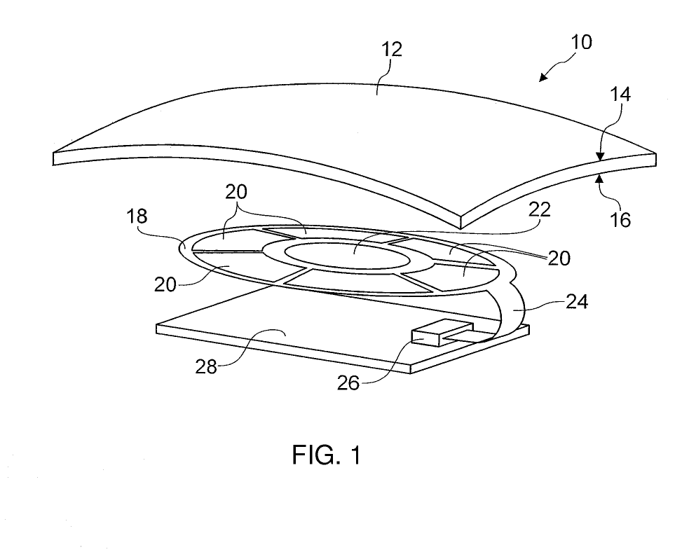

Referring now to the figures of the drawing in detail and first, particularly, to FIG. 1 thereof, there is shown a capacitive touch switch 10 in the disassembled state. A touch panel 12 is of a curved configuration in the illustrated portion. The curvature is reproduced both on a top side 14 and also on an opposite underside 16. The illustrated curvature is an example of a freely shaped surface. A circuit carrier 18 carries capacitive sensor elements 20 and at the center of the circular circuit carrier 18 has a round cut-out 22 for increasing the adaptability of the circuit carrier 18 to the freely shaped surface. The feed lines 30 to the capacitive sensor elements 20 which are electrically insulated from each other pass by way of a cable tail 24 to which a plug 26 is fitted for connecting the circuit carrier 18 to a circuit board 28.

Upon fitment of the circuit carrier 18 to the underside 16 of the touch panel 12 the circuit carrier 18 is deformed and is flexibly adapted to the three-dimensional shape of the underside 16. This guarantees that the capacitive sensor elements 20 are arranged at a uniform spacing relative to the top side 14 of the touch panel 12.

In the illustrated embodiment there are provided six capacitive sensor elements 20, which are of a segment-like shape, on the circuit carrier 18. Depending on how many independent touch switches 10 are respectively required, more or fewer capacitive sensor elements 20 can be arranged on the circuit carrier 18.

The capacitive sensor elements 20 can be arranged either on the front side or the rear side of the circuit carrier 18, but also both on the front side and also the rear side of the circuit carrier 18. The choice is driven by technical manufacturing process aspects, such as for example avoiding damage to the sensor elements 20 by adhesive or by a pressing punch. In addition more flexible usability of the circuit carrier 18 is possible. Thus it is possible for example to react to greatly reduced space situations under the touch panel 12 and the circuit carrier 18 can be fitted with a straight cable tail 24 in contrast to the bent-over cable tail 24 shown in FIG. 1.

In another embodiment the capacitive sensor elements 20 can be integrated into the circuit carrier 18, for example by coating the sensor elements 20 with the material of the circuit carrier 18. That provides that the capacitive sensor elements 20 are protected from damage in relation to mechanical effects such as dust or other small-size particles.

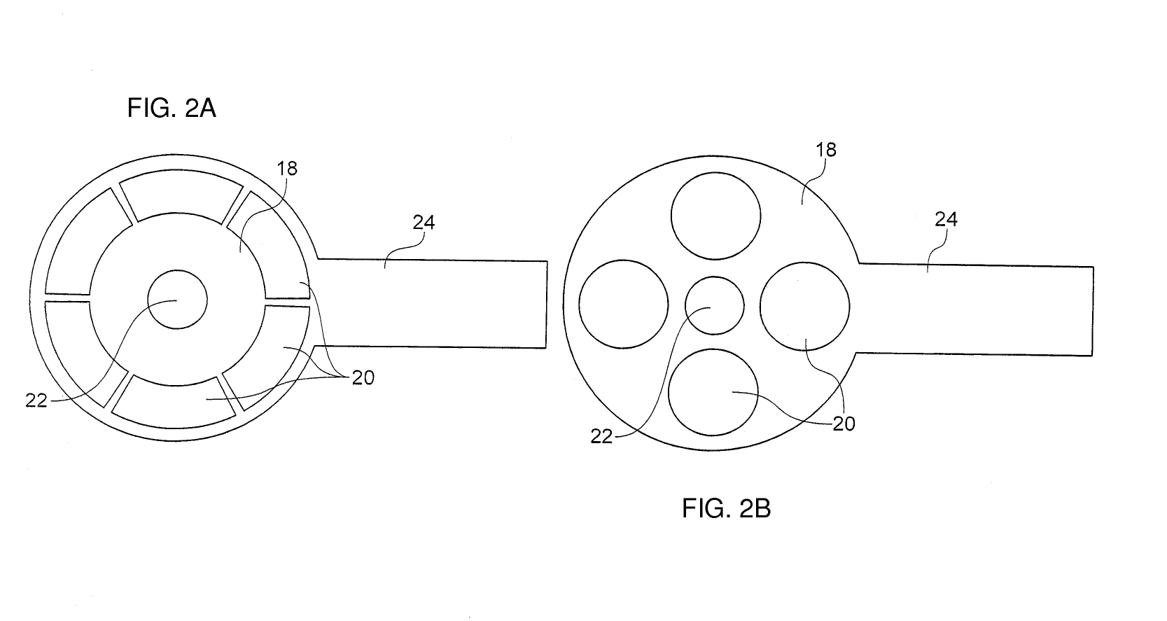

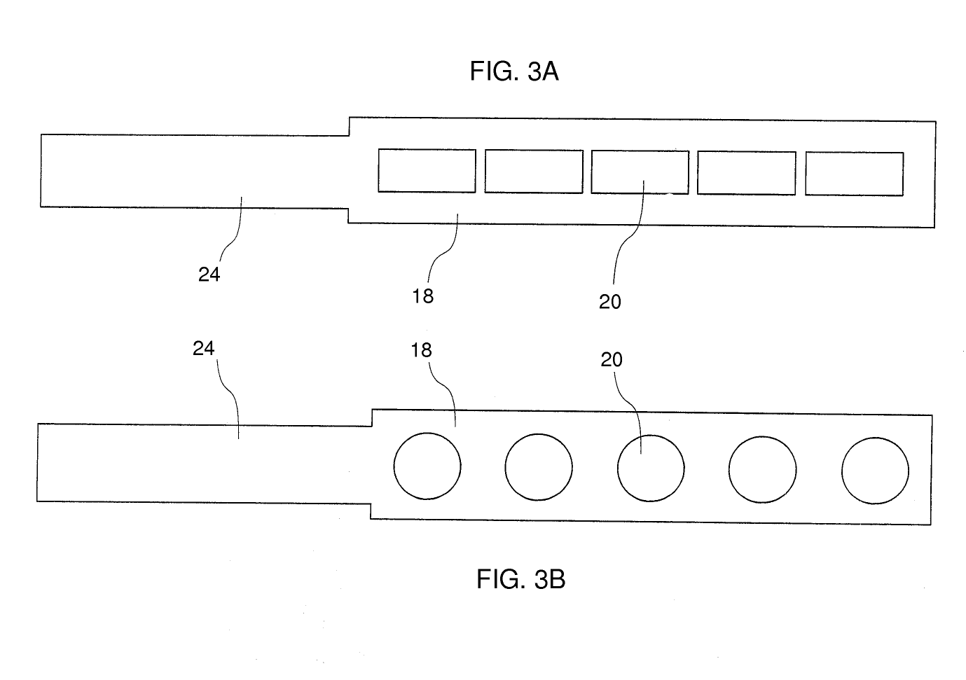

FIGS. 2A and 2B show two round circuit carriers 18 with a central cut-out 22. Basically any desired shape is possible for the circuit carrier 18. The same applies to the capacitive sensor elements 20. By way of example, FIG. 2A shows a circuit carrier 18 with sensor elements 20 of a segment-like configuration while FIG. 2B shows a circuit carrier 18 with round sensor elements 20. FIGS. 3A and 3B show circuit carriers 18 which are of a strip-shaped configuration with rectangular sensor elements (FIG. 3A) and round sensor elements (FIG. 3B).

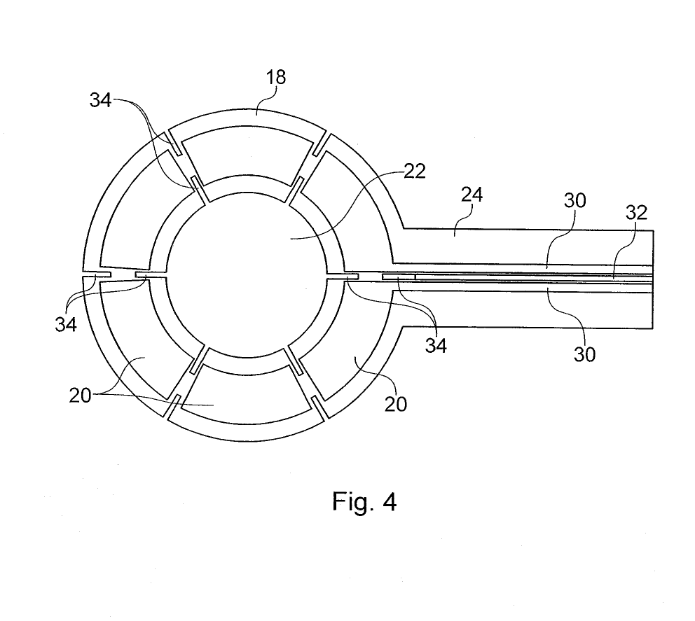

FIG. 4 shows an annular circuit carrier 18 with a large central cut-out 22, on which segment-shaped sensor elements 20 are disposed. In addition, shown by way of example are feed lines 30 running to two of the six illustrated sensor elements 20, passing by way of the cable tail 24. By way of example, an interference suppression element 32 is indicated between the feed lines 30. The end of the cable tail 24 can be provided with a plug and can thus be easily connected to a circuit board 28. A plug however is not necessarily required. Thus for example the circuit carrier 18 can be electrically connected directly to the circuit board 28 by clamping terminal contacting. To improve adaptability of the circuit carrier 18 to a freely shaped underside 16 of a touch panel 12, a plurality of incisions 34 are provided besides the cut-out 22.

The circuit carrier 18 can be fixed to the underside 16 of the touch panel 12 in differing ways. On the one hand the circuit carrier 18 can be mounted immediately and directly to the underside 16 or on the other hand it can be fitted in encapsulated form, in which case fixing to the underside 16 can be permanent or releasable.

In the encapsulated form, it is possible to employ full encapsulation with completely enclosed front and rear sides of the circuit carrier 18, or partial encapsulation. In the case of partial encapsulation for example only the rear side of the circuit carrier 18 is enclosed or encapsulated whereas the front side remains unencapsulated. A reversed, fragment-like implementation of the encapsulation on the circuit carrier 18 is also possible.

Independently of full or partial encapsulation however the encapsulation is such that it is adapted to the freely shaped underside 16 of the touch panel 12, in other words it forms a counterpart to the freely shaped underside 16. The circuit carrier 18 in the encapsulation is adapted to the freely shaped underside 16 of the touch panel 12 in corresponding fashion.

The use of encapsulation permits easier assembly as the circuit carrier 18 can be assembled without particular precautionary measures and destruction of the circuit carrier 18 is excluded.

In an alternative embodiment of the invention, the circuit carrier 18 is integrated into the touch panel 12. For that purpose the circuit carrier 18 is arranged suitably adapted to follow the desired free shape of the touch panel 12 when casting or injecting the touch panel 12 and the circuit carrier 18 is enclosed by the material of the touch panel 12. In this configuration only the cable tail 24 projects for example out of the underside 16 of the touch panel 12.

1. A capacitive touch switch, comprising:
a touch panel having a top side and an underside;
a circuit board disposed at a spacing distance below said underside of said touch panel;
a flexible and three-dimensionally deformable circuit carrier configured for adaptation to a freely shaped surface of said underside of said touch panel; and
a capacitive sensor element disposed on said circuit carrier and at said underside of said touch panel and in electrically conductive contact with said circuit board.

2. The capacitive touch switch according to claim 1 wherein said capacitive sensor element is integrated into said circuit carrier.

3. The capacitive touch switch according to claim 1, wherein said circuit carrier has a front side and a rear side, and said capacitive sensor element is disposed on at least one of said front side and said rear side of said circuit carrier.

4. The capacitive touch switch according to claim 1, wherein said circuit carrier includes one or more elements selected from the group consisting of interference suppression elements, shielding elements, and protection elements.

5. The capacitive touch switch according to claim 1, wherein said circuit carrier has a shape selected from the group consisting of strip-shaped, round, and oval.

6. The capacitive touch switch according to claim 1, wherein said circuit carrier includes features for improving an adaptability thereof selected from the group consisting of incisions and cut-outs.

7. The capacitive touch switch according to claim 1, wherein said capacitive sensor element has a configuration selected from the group consisting of rectangular, square, round, oval, and segment-shaped.

8. The capacitive touch switch according to claim 1, wherein said circuit carrier is permanently connected to said underside of said touch panel and adapted to a free form shape of said underside.

9. The capacitive touch switch according to claim 8, wherein said circuit carrier is permanently connected to said underside of said touch panel by adhesive or riveting.

10. The capacitive touch switch according to claim 1, wherein said circuit carrier is releasably connected to said underside of said touch panel and adapted to a free form shape of said underside.

11. The capacitive touch switch according to claim 10, wherein said circuit carrier is releasably connected to said underside by peening, screwing, or by way of compression springs, clamps or latching hooks.

12. The capacitive touch switch according to claim 1, wherein said circuit carrier has a cable tail and feed lines to said capacitive sensor element pass by way of said cable tail.

13. The capacitive touch switch according to claim 1, wherein said circuit carrier is disposed directly on said underside of said touch panel.

14. The capacitive touch switch according to claim 1, wherein said circuit carrier is at least partially encapsulated with an encapsulation adapted to a freely shaped underside of said touch panel and disposed at said underside of said touch panel.

15. The capacitive touch switch according to claim 1, wherein said capacitive sensor element is one of a plurality of capacitive sensor elements arranged on said circuit carrier.

16. The capacitive touch switch according to claim 15, wherein said plurality of capacitive sensor elements are electrically insulated from one another.

17. A capacitive touch switch, comprising:
a touch panel having a top side and an underside;
a circuit board disposed at a spacing distance below said underside of said touch panel;
a flexible and three-dimensionally deformable circuit carrier configured for adaptation to a freely shaped surface of said underside of said touch panel and at least partially integrated into said touch panel; and
a capacitive sensor element disposed on said circuit carrier and at said underside of said touch panel and in electrically conductive contact with said circuit board.
